(19) United States
(12) Patent Application Publication
(10) Pub. No.: US 2019/0176589 A1
(43) Pub. Date: Jun. 13, 2019

(54) HEMMING STRUCTURE FOR HYBRID-TYPE DOOR

(71) Applicants: Hyundai Motor Company, Seoul (KR); Kia Motors Corporation, Seoul (KR)

(72) Inventors: Ki Hyun Choi, Seoul (KR); Jai Hak Kim, Gunpo (KR)

(21) Appl. No.: 16/002,439

(22) Filed: Jun. 7, 2018

(30) Foreign Application Priority Data
Dec. 13, 2017 (KR) 10-2017-0170883

(51) Int. Cl. B60J 5/04

(52) U.S. Cl. CPC B60J 5/0469; B60J 5/0484; B60J 5/0463

(57) ABSTRACT

Disclosed is a structure for a hybrid-type door, which is capable of preventing deformation caused by difference in thermal expansion coefficient between an outer panel of aluminum alloy and an inner panel of iron steel. The structure for a hybrid-type door may include an inner panel and an outer panel made of different material from the inner panel. In particular, an end portion of the inner panel and an end portion of the outer panel may be provided at a contact area, and the end portion of the inner panel may be hemmed by the end portion of the outer panel. A sealer may be applied to the contact areas at which the inner panel and the outer panel may be brought into contact with each other, and the contact area of the inner panel may include a non-contact space being free from contacting the sealer.

### CROSS REFERENCE TO RELATED APPLICATION

The present application claims priority to Korean Patent Application No. 10-2017-0170883, filed Dec. 13, 2017, the entire contents of which is incorporated herein for all purposes by this reference.

### TECHNICAL FIELD

The present invention relates to a hemming structure for a hybrid-type door, which may prevent deformation caused by difference in thermal expansion coefficient between an outer panel of aluminum alloy and an inner panel of iron steel.

### BACKGROUND OF THE INVENTION

Generally, a vehicle door has a structure including two or more panels connected to each other for weight reduction and rigidity maintenance.

For example, FIG. 1 shows sectional views of a hemming structure in the related art and a problem of a conventional door. As shown in FIG. 1, the hemming structure of the conventional door includes an inner panel 10 disposed at the inner side of a vehicle body, and an outer panel 20 disposed at the outer side of the vehicle body. At a junction area between the inner panel 10 and the outer panel 20, a flange 21 protruding more than the inner panel 10 by a predetermined length is disposed at an end of the outer panel 20, and a hemming structure is formed by being bent such that the flange 21 is brought into contact with an opposite surface of the inner panel 10 (a surface facing the interior of the vehicle).

Further, a sealer 30 is applied onto the junction area between the inner panel 10 and the outer panel 20 to prevent penetration of moisture and foreign matter. The sealer 30 has an elongation property of about 10%, and an impact property of about 35 N/mm, and is cured at a temperature greater than room temperature, preferably at the atmospheric temperature range of the painting process. The sealer 30 is cured as it passes through an oven during the painting process and maintains the impact property while increasing the bonding force between the inner and outer panels.

Meanwhile, in recent years, in order to improve the physical properties of a door for weight reduction and rigidity maintenance, a hybrid-type door, in which the outer panel is made of aluminum alloy and the inner panel is made of iron steel material, has been proposed and used.

In the related art, the door of the hybrid type may be manufactured by hemming process as shown in \textcircled{0} of FIG. 1, and then it may pass through an oven during the painting process. As shown \textcircled{2} in of FIG. 1, due to the difference in thermal expansion coefficient between the inner panel 10 of the iron steel and the outer panel 20 of the aluminum alloy, the outer panel 20 of the aluminum alloy is expanded greater than the inner panel 10 of the iron steel. Then, a sealer is cured as shown in \textcircled{3} of FIG. 1 with the outer panel 20 expanded more than the inner panel 10. During the process of cooling after the painting process with the outer panel 20 and the inner panel 10 bonded together, the outer panel 20 of the aluminum alloy may contact greater than the inner panel 10 of steel as shown in \textcircled{4} of FIG. 1, thereby causing distortion.

Meanwhile, if the elongation of the sealer used in the hybrid-type door is improved, distortion caused by the difference in thermal expansion coefficient between different materials may be prevented, but a sealer with high elongation may not be used because of its low rigidity and bonding performance.

The foregoing is intended merely to aid in the understanding of the background of the present invention, and is not intended to mean that the present invention falls within the purview of the related art that is already known to those skilled in the art.

### SUMMARY OF THE INVENTION

In preferred aspects, the present invention provides a structure for a hybrid-type door and a method of manufacturing the structure. In preferred embodiment, the door may have a hemming structure.

The term “hemming”, “hem” or “hemmed” as used herein refers to a structure that is formed by folding a part near an edge of a first article to surround an edge of a second article, such that the edge part of the second article may be inserted inside into the folded part of the first article and the edge of the second article is not exposed to outside. For instance, the end portion of a first panel may be surrounded or hemmed by the end portion of a second panel.

Accordingly, deformation at the hemmed door caused by difference in thermal expansion coefficient between an outer panel of aluminum alloy and an inner panel of iron steel may be prevented.

In embodiments, the door may be a hybrid-door. The term “hybrid-type door” or “hybrid door” as used herein refers to a door structure made of non-homogeneous materials, such as at least two different metal or steel materials. For instance, the hybrid-type door in the invention may include at least two or more of steels, which may include an iron steel, carbon steel, aluminum alloy, stainless steel or the like.

In one aspect of the present invention, there is provided a structure for a hybrid-type door. The structure may include an inner panel and an outer panel made of different material from the inner panel. An end portion of the inner panel and an end portion of the outer panel may contact at a contact area, and the end portion of the inner panel may be hemmed by the end portion of the outer panel. A sealer may be applied to the contact area at which the inner panel and the outer panel may be brought into contact with each other, and the contact area of the inner panel is formed to include a non-contact space and the sealer is not applied to the non-contact space

The “different material” or “different materials” as used herein refers to at least two or more of materials that have different compositions or components from the other material in an amount of about 10 wt % or greater, by about 20 wt % or greater, by about 30 wt % or greater, by about 40 wt % or greater, by about 50 wt % or greater, by about 60 wt % or greater, by about 70 wt % or greater, by about 80 wt % or greater, or by about 90 wt % or greater of the total weight of the material. For example, the different material from the other material may have different compositions, such that the properties such as density, thermoelectric coefficient, thermal expansion coefficient, thermal contraction coefficient, tensile strength or elongation may be different by about 5%, by about 10%, by about 20%, by about 30%, by about 40%, by about 50%, by about 60%, by about 70%, by about 80%, or by about 10% in the measurements.

In embodiments, the sealer is curable. The term “cure”, “curing”, “curable” or “curing process” as used herein refers a hardening process of a resin, a binder or a polymer, e.g., such hardening indicated by an increase of molecular weight such as by forming a cross-linked structure in the resin, the binder or the polymer and forming a plastic material. The curing may be performed by applying a light (e.g., UV light), heat, or electron beam, or adding chemical additives to the resin or the polymer.

The non-contact space of the inner panel may include a protrusion formed by being bent in a direction opposed to the contact area with the outer panel.

The outer panel may include a flange extending from the contact area of the outer panel to surround the contact area of the inner panel, and the flange may be formed with a through-hole through which the protrusion of the inner panel may be inserted.

The inner panel may include a plurality of the non-contact spaces arranged apart by a predetermined distance from each other.

The inner panel may be made of an iron steel material, and the outer panel may be made of an aluminum alloy.

The term “aluminum alloy” as used herein refers to an alloy material that contains aluminum as dominant material, for example, greater than about 50 wt %, greater than about 55 wt %, greater than about 60 wt %, greater than about 65 wt %, greater than about 70 wt %, greater than about 75 wt %, greater than about 80 wt %, greater than about 85 wt %, greater than about 90 wt %, greater than about 95 wt %, greater than about 96 wt %, greater than about 97 wt %, greater than about 98 wt %, or greater than about 99 wt %, based on the total weight of the aluminum alloy.

The term “iron steel” as used herein refers to a steel that contains iron and carbon as major components of the steel composition such that the iron and carbons are alloyed for improving the physical properties of the steel. For instance, iron may be a dominant material in the iron steel, for example, greater than about 50 wt %, greater than about 55 wt %, greater than about 60 wt %, greater than about 65 wt %, greater than about 70 wt %, greater than about 75 wt %, greater than about 80 wt %, greater than about 85 wt %, greater than about 90 wt %, greater than about 95 wt %, greater than about 96 wt %, greater than about 97 wt %, greater than about 98 wt %, or greater than about 99 wt %, based on the total weight of the iron steel.

The sealer may include a resin having an elongation of about 20 to 40%.

The “elongation” as used herein refers to an expansion property of material. For example, when the object or material is under the stress or force applied just before its breakage or complete deformation, the change of the length or amount of extension varied under that stress or the force may be calculated as a percentage to the original length or the original state.

Further provided is a vehicle that may include a structure for the door as described herein.

Still further provided herein is a method of manufacturing a hybrid-door for a vehicle. The method may include: providing an inner panel comprising one or more protrusions and an outer panel made of different material from the inner panel, applying a sealer at a contact area on the outer panel, wherein the contact area is a surface that the inner panel contact with the outer panel and the sealer is not applied at least portions of the contacting area where the one or more protrusions of the inner panel may locate, bring the inner panel and the outer panel at the contact area, heat treating the inner panel and the outer panel, and cooling the heat treated inner panel and the outer panel.

The one or more protrusions of the inner panel may be formed by bending the inner panel in a direction opposed to the contacting area with the outer panel.

Preferably, the outer panel may include a flange extending from the contact area of the outer panel to surround the contact area of the inner panel, and the flange may be formed with a through-hole through which the protrusion of the inner panel may be inserted.

The inner panel may suitably be made of an iron steel material, and the outer panel may suitably be made of an aluminum alloy.

The sealer may suitably include a resin having an elongation of about 20 to 40%.

The heat treatment may be performed at a temperature of about 180 to 200° C.

The method may further include painting the inner panel and the outer panel during the heat treatment.

In various aspects of the present invention, when the outer panel and the inner panel, which are made of different materials, are hemmed, the sealer with high elongation may be applied to the contact areas of the inner panel and the outer panel, and the non-contact space being free from contacting the sealer may be provided at the contact area of the inner panel. Further, since the non-contact space, which may be prevented from being bonded to the contact area of the inner panel by the sealer, may be formed in the shape of a protrusion, the volume of the inner panel at the contact area thereof may be increased. Accordingly, distortion of the hemmed structure may be suppressed by reducing differences in the expansion amount and the contraction amount caused by difference in thermal expansion coefficient between the different materials may be prevented.

Other aspects of the invention are disclosed infra.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 shows sectional views of a hemming structure in the related art;

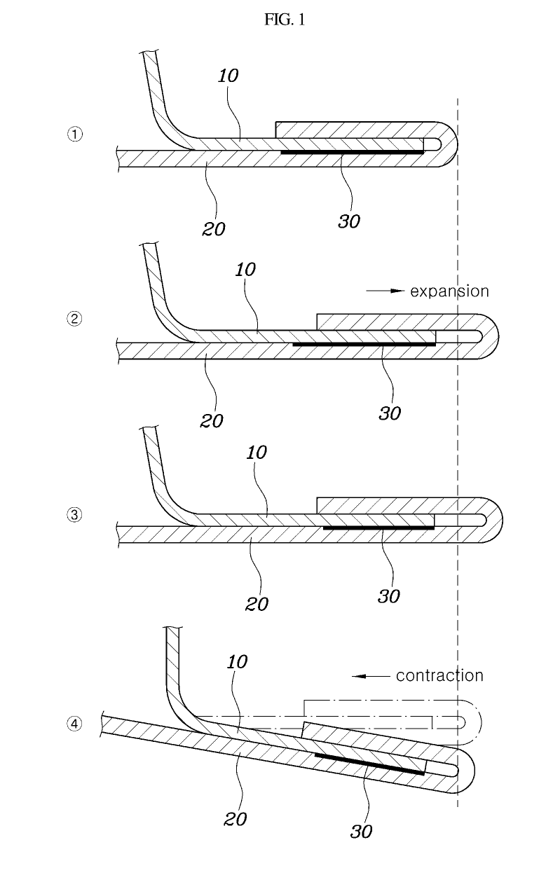

FIG. 2 shows an exemplary sectional view of an exemplary hemming structure for a hybrid-type door according to an exemplary embodiment of the present invention;

FIG. 3 shows an exemplary view of an exemplary method of manufacturing an exemplary hybrid-type door according to an exemplary embodiment of the present invention;

FIG. 4 shows views of expansion and contraction during an exemplary painting process of an exemplary hybrid-type door according to an exemplary embodiment of the present invention;

FIG. 5 shows an exemplary sectional view of an exemplary hemming structure for an exemplary hybrid-type door according to an exemplary embodiment of the present invention; and

FIG. 6 shows an exemplary view of an exemplary method of manufacturing an exemplary hybrid-type door according to an exemplary embodiment of the present invention.

### DETAILED DESCRIPTION OF THE INVENTION

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprise”, “include”, “have”, etc. when used in this specification, specify the presence of stated features, regions, integers, steps, operations, elements and/or components but do not preclude the presence or addition of one or more other features, regions, integers, steps, operations, elements, components, and/or combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinbelow, various exemplary embodiments of the present invention will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

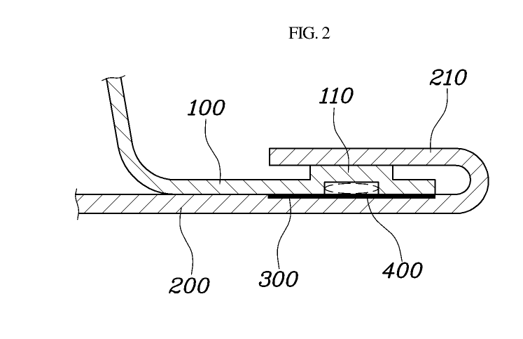

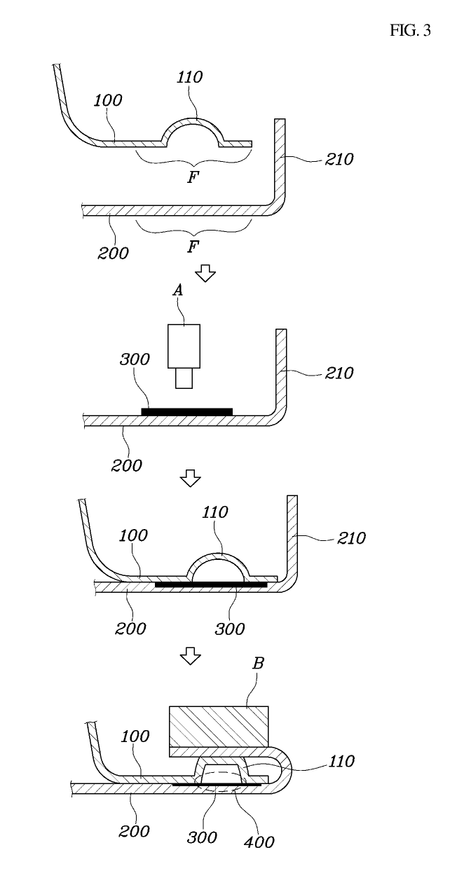

FIG. 2 shows a sectional view of an exemplary hemming structure for an exemplary hybrid-type door according to an exemplary embodiment of the present invention; and FIG. 3 shows a view of an exemplary method of manufacturing an exemplary hybrid-type door according to an exemplary embodiment of the present invention.

As shown in the drawings, a hemming structure for a hybrid-type door according to an exemplary embodiment of the present invention may include an inner panel 100 and an outer panel 200 made of different materials. For example, the inner panel 100 may be made of an iron steel material having a small thermal expansion coefficient and the outer panel 200 may be made of aluminum material having a high thermal expansion coefficient. Herein, the iron steel material may include an iron-based alloy, and the aluminum alloy may include an aluminum-based alloy.

The inner panel 100 and the outer panel 200 may be parts constituting a vehicle door, and the shapes thereof may be variously changed depending on the shape of the vehicle door.

Preferably, each of the inner panel 100 and the outer panel 200 may be provided to contact at a contact area at which end portions thereof may be brought into contact with each other. The end portions of the inner panel 100 and the outer panel 200 refer to edges of the inner panel 100 and the outer panel 200.

The inner panel 100 and the outer panel 200 may be brought into contact with each other at the end portions thereof. Here, the end portion of the outer panel 200 may be provided with a flange 210 extending longer than the end portion of the inner panel 100 to surround the end portion of the inner panel 100. Accordingly, the flange 210 of the outer panel 200 may be bent to hem the end portion of the inner panel 100.

Here, each of the inner panel 100 and the outer panel 200 may be provided with an area at which the end portions thereof are brought into contact with each other, and hereinafter, this area is referred to as a ‘contact area F’.

Thus, a sealer 300 may be applied to the contact area F, at which the inner panel 100 and the outer panel 200 are brought into contact with each other, so as to improve the bonding force therebetween and to prevent moisture and foreign matter from penetrating into the contact area F.

As the sealer 300 used in the embodiment, a resin that may be curable at high temperature (e.g., 180 to 200° C.) may be used, and the curing may occur during the painting process after hemming the structure of the hybrid-type door. The high temperature curing sealer may include, for example, epoxy-type sealer. However, the inner panel 100 and the outer panel 200 may be attached to each other as the sealer 300 is cured. Because the inner panel 100 and the outer panel 200, which are different materials having different thermal expansion coefficients, are expanded to different levels when exposed to the high temperature during the painting process, the sealer 300 with high elongation property may be suitably used in order to prevent distortion that may occur during contracting to different levels as they are cooled in this state. For example, the sealer 300 may suitably maintain the elongation of about 20 to 40%.

Even if the sealer 300 with high elongation is used, there may be differences in the contraction amount due to different thermal expansion coefficients when the inner panel 100 and the outer panel 200 contract by the sealer 300 cured in the painting process while being cooled in the state where the inner panel 100 and the outer panel 200 are bonded together. Preferably, a non-contact space 400 being free from contacting the sealer 300 may be provided at a part of the contact area F of the inner panel 100 to prevent distortion caused by the differences in contraction.

Accordingly, the non-contact space 400 may be provided on the inner panel 100 and may absorb the contraction amount of the outer panel 200 that contracts greater than the inner panel 100. As such, distortion between the inner panel 100 and the outer panel 200 may be prevented.

The non-contact space 400 provided on the inner panel 100 may be formed by a protrusion 110 that may be formed by being bent in a direction opposed to the contact area F or a surface contacting with the outer panel 200. As the protrusion 110 forming the non-contact space 400 may be provided in the contact area F of the inner panel 100, the volume of the inner panel 100 may be increased, and the expansion amount and the contraction amount of the outer panel 200 having a large thermal expansion coefficient may be complemented by the increased volume of the inner panel 100. For instance, the inner panel 100 of iron steel having a small thermal expansion coefficient may increase the volume of the contact area F to increase the expansion amount and the contraction amount, and the outer panel 200 of aluminum having a high thermal expansion coefficient has a volume less than that of the inner panel 100 in the contact area, therefore the expansion amount and the contraction amount of the outer panel 200 may be similar to those of the inner panel 100 in the contact area F. A plurality of the non-contact spaces 400 may be formed on the inner panel 100, which may be arranged apart by a predetermined distance from each other. For instance, the plurality of the non-contact spaces may be formed at uniform intervals or may be formed at various intervals on in the inner panel.

A method for manufacturing the hybrid-type door configured as described above according to an embodiment of the present invention will be described with reference to the accompanying drawings.

As shown in FIG. 3, the inner panel 100 and the outer panel 200 for each shape may be prepared. Here, the inner panel 100 may be formed with the protrusion 110 bent to protrude upward from the contact area F.

When the inner panel 100 and the outer panel 200 are prepared, the sealer 300 may be applied onto the contact area F of the outer panel 200 by using an application tool A.

After applying the sealer 300, the inner panel 100 may be disposed on the outer panel 200 such that the contact area F of the inner panel 100 and the contact area F of the outer panel 200 may be brought into contact with each other.

Here, the sealer applied onto the contact area F of the outer panel 200 may be in contact with the remaining area except the protrusion 110 formed on the contact area F of the inner panel 100.

After bringing the inner panel 100 into contact the outer panel 200, the flange 210 of the outer panel 200 may be bent by using a hemming tool B to hem the end portion of the inner panel 100.

At the time of completion of hemming, the protrusion 110 formed on the contact area F of the inner panel 100 may form the non-contact space 400 being free from contacting the sealer.

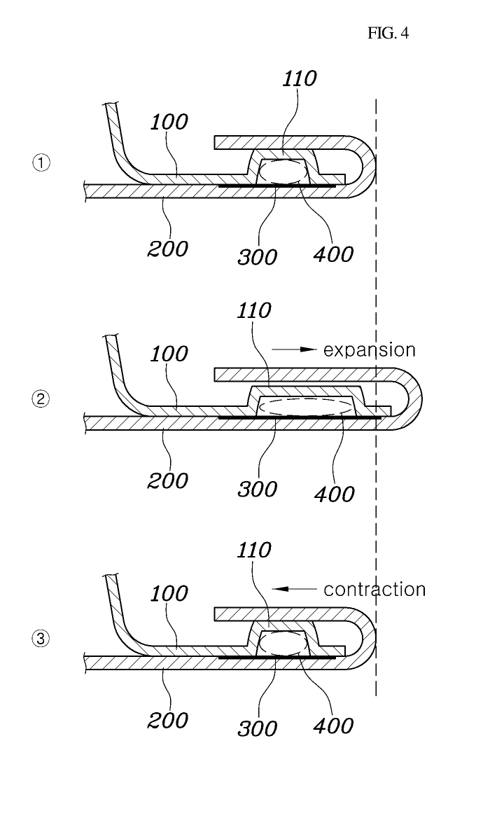

Meanwhile, FIG. 4 shows views of expansion and contraction during an exemplary painting process of an exemplary hybrid-type door according to an exemplary embodiment of the present invention.

As shown in \textcircled{1} of FIG. 4, after hemming, the inner panel 100 including the protrude non-contact space 400 where the sealer 300 is not applied and the outer panel 200 may be exposed to a high temperature (e.g., about 180 to 200° C.) for heat treatment during the painting process.

Then, as shown in \textcircled{2} of FIG. 4, the inner panel 100 and the outer panel 200 may expand according to the thermal expansion coefficient thereof, respectively. Here, the outer panel 200 of aluminum having a large thermal expansion coefficient may be expanded by a predetermined amount in the contact area, and the inner panel 100 of steel having a small thermal expansion coefficient may be expanded less than the outer panel 200 in the contact area F. Since the volume of the contact area is increased by the protrusion 110, the expansion amount may be increased, such that the inner panel may be expanded to a level similar to the expansion amount of the outer panel 200. In this state, the inner panel 100 and the outer panel 200 may be bonded by curing of the sealer 300.

Further, as shown in \textcircled{3} of FIG. 4, when the cooling process proceeds after the painting process, contrary to the case of expansion, the outer panel 200 of aluminum having a large thermal expansion coefficient may be contracted by a predetermined amount in the contact area, and the inner panel 100 of steel having a small thermal expansion coefficient may be contracted less than the outer panel 200 in the contact area. Since the volume of the contact area is increased by the protrusion 110, the contraction amount may be increased, such that the inner panel may be contracted to a level similar to the contraction amount of the outer panel 200.

Further, when the inner panel 100 and the outer panel 200 are contracted, an area where the inner panel 100 and the outer panel 200 are joined together by the sealer 300 may be reduced by the non-contact space 400 formed by the protrusion 110 of the inner panel 100, thereby reducing distortion due to different contraction amounts.

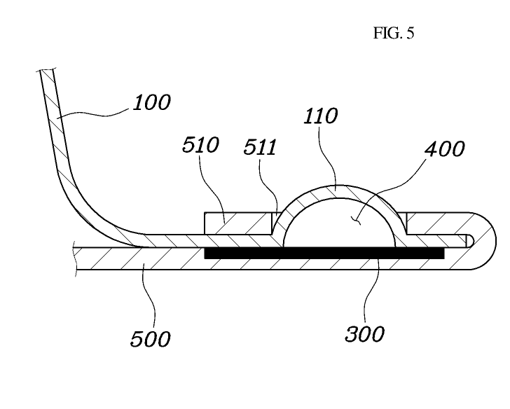

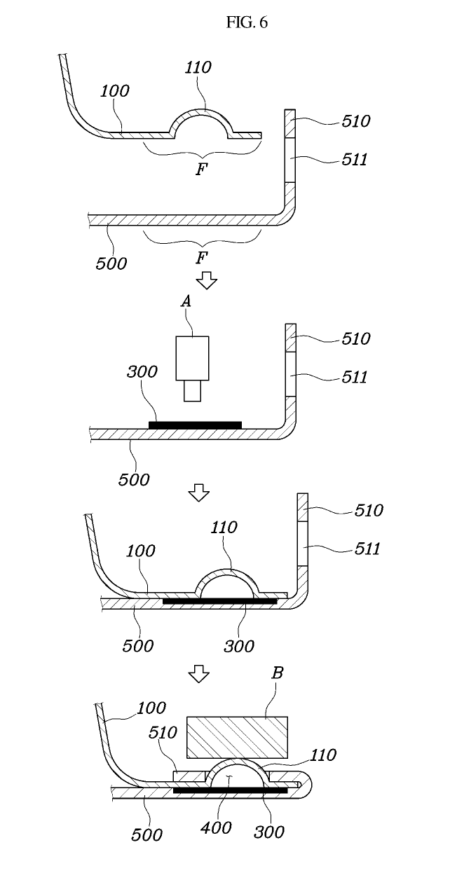

Meanwhile, FIG. 5 shows a sectional view of a hemming structure for a hybrid-type door according to an exemplary embodiment of the present invention; and FIG. 6 shows a view of an exemplary method for manufacturing an exemplary hybrid-type door according to an exemplary embodiment of the present invention.

As shown in FIGS. 5 and 6, the hemming structure for a hybrid-type door according to an exemplary embodiment of the present invention is a modification in which the shape of the outer panel in the above described embodiment is modified.

The hemming structure for a hybrid-type door according to the embodiment of FIG. 5, as in the above described embodiment, may include the inner panel 100 provided with a protrusion, and an outer panel 500 hemming the end portion of the inner panel 100. The sealer 300 may be applied to a contact area, at which the inner panel 100 and the outer panel 500 may be brought into contact with each other, and the non-contact space 400 may be formed by the protrusion 110 of the inner panel 100.

However, the outer panel 500 may be provided with a flange 510 extending from the contact area F thereof to surround the contact area F of the inner panel 100. Particularly, the flange 510 may be formed with a through-hole 511 into which the protrusion 110 of the inner panel 100 may be inserted.

Preferably, the through-hole 511 may have a size equal to or greater than that of the protrusion 110 formed in the inner panel 100. Accordingly, as the flange 510 of the outer panel 500 may be hemmed around the end portion of the inner panel 100, the protrusion 110 of the inner panel 100 may be inserted into the through-hole 511 of the outer panel 500, thereby mechanically coupling the inner panel 100 and the outer panel 500 together.

A hemming method for the hybrid-type door as show in of FIG. 6 will be described with reference to the accompanying drawings.

As shown in FIG. 6, the inner panel 100 and the outer panel 500 for each shape may be prepared. Here, the inner panel 100 may be formed with the protrusion 110 bent to protrude upward from the contact area. Further, the flange of the outer panel 500 may be formed with the through-hole 511 into which the protrusion 110 of the inner panel 100 may be inserted.

When the inner panel 100 and the outer panel 500 are prepared, the sealer 300 may be applied onto the contact area F of the outer panel 500 by using the application tool A.

After applying the sealer 300, the inner panel 100 may be disposed on the outer panel 500 such that the contact area F of the inner panel 100 and the contact area F of the outer panel 500 are brought into contact with each other.

Here, the sealer 300 applied onto the contact area F of the outer panel 500 may be in contact with the remaining area except the protrusion 110 formed on the contact area F of the inner panel 100.

After bring the inner panel 100 into contact the outer panel 500, the flange 510 of the outer panel 500 may be bent by using the hemming tool B to hem the end portion of the inner panel 100. Thereby, as the protrusion 110 of the inner panel 100 may be inserted into the through-hole 511 of the outer panel 500, the mechanical bonding force between the inner panel 100 and the outer panel 500 may be increased.

At the time of completion of hemming, the protrusion 110 formed on the contact area F of the inner panel 100 may form the non-contact space 400 being free from contacting the sealer 300.

As the non-contact space 400 is formed at the time of completion of hemming, during the expansion and contraction occurring in the painting process as in the above described embodiment, differences in the expansion amount and the contraction amount caused by difference in thermal expansion coefficient between the inner panel 100 and the outer panel 500 may be reduced.

Further, in an exemplary embodiment, as the protrusion 110 of the inner panel 100 is inserted into the through-hole 511 of the outer panel 500, the mechanical bonding force between the inner panel 100 and the outer panel 500 may be increased and the inner panel 100 and the outer panel 500 may be mechanically fastened to each other during the contraction, whereby it is possible to reduce distortion between the inner panel 100 and the outer panel 500.

Although various preferred embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. A structure for a door, comprising:
an inner panel; and
an outer panel made of different material from the inner panel,
wherein an end portion of the inner panel and an end portion of the outer panel contact at a contact area,
wherein the end portion of the inner panel is hemmed by the end portion of the outer panel,
wherein the contact area at which the inner panel and the outer panel are brought into contact with each other comprises a sealer, and
wherein the inner panel comprises a non-contact space at the contact area and the sealer is not applied to the non-contact space.

2. The structure of claim 1, wherein the non-contact space of the inner panel comprises a protrusion formed by being bent in a direction opposed to the contacting area with the outer panel.

3. The structure of claim 2, wherein the outer panel comprises a flange extending from the contact area of the outer panel to surround the contact area of the inner panel, and
the flange is formed with a through-hole through which the protrusion of the inner panel is inserted.

4. The structure of claim 1, wherein the inner panel comprises a plurality of the non-contact spaces arranged apart by a predetermined distance from each other.

5. The structure of claim 1, wherein the inner panel is made of an iron steel material, and the outer panel is made of an aluminum alloy.

6. The structure of claim 1, wherein the sealer comprises a resin having an elongation of about 20 to 40%.

7. A vehicle comprising a structure of claim 1.

8. A method of manufacturing a door for a vehicle, comprising:
providing an inner panel comprising one or more protrusions and an outer panel made of different material from the inner panel,
applying a sealer at a contact area on the outer panel, wherein the contact area is a surface that the inner panel contact with the outer panel and the sealer is not applied at least portions of the contacting area where the one or more protrusions of the inner panel locate,
bring the inner panel and the outer panel at the contact area,
heat treating the inner panel and the outer panel, and
cooling the heat treated inner panel and the outer panel.

9. The method of claim 8, wherein the one or more protrusions of the inner panel are formed by being bent in a direction opposed to the contacting area with the outer panel.

10. The method of claim 8, wherein the outer panel comprises a flange extending from the contact area of the outer panel to surround the contact area of the inner panel, and the flange is formed with a through-hole through which the protrusion of the inner panel is inserted.

11. The method of claim 8, wherein the inner panel is made of an iron steel material, and the outer panel is made of an aluminum alloy.

12. The method of claim 8, wherein the sealer comprises a resin having an elongation of about 20 to 40%.

13. The method of claim 8, wherein the heat treatment is performed at a temperature of about 180 to 200° C.

14. The method of claim 8, further comprising painting the inner panel and the outer panel during the heat treatment.
